(19) United States
(12) Patent Application Publication
(10) Pub. No.: US 2018/0043725 A1
(43) Pub. Date: Feb. 15, 2018

(54) OPTICAL DEVICE INCLUDING ZERO-ORDER IMAGERY

(71) Applicant: CCL SECURE PTY LTD, Craigieburn, Victoria (AU)

(72) Inventors: Gary Fairless Power, Craigieburn, Victoria (AU); Phei Lok, Craigieburn, Victoria (AU)

(73) Assignee: CCL SECURE PTY LTD, Craigieburn, Victoria (AU)

(21) Appl. No.: 15/554,408

(22) PCT Filed: Mar. 3, 2016
(86) PCT No.: PCT/AU2016/050142

§ 371 Date: Aug. 29, 2017

(30) Foreign Application Priority Data
Mar. 6, 2015 (AU) 2015100281
Mar. 6, 2015 (AU) 2015900802

(51) Int. Cl. B42D 25/378; B42D 25/342; G02B 3/00; B42D 25/351; B42D 25/29; G02B 5/18

(52) U.S. Cl. CPC B42D 25/378; B42D 25/29; G02B 5/1842; G02B 3/0006; B42D 25/351; B42D 25/342; B42D 25/328

(57) ABSTRACT

An optical device including: a first surface; and an arrangement of pixels on the first surface, wherein a plurality of the pixels includes a zero-order diffraction element, such that each zero-order diffraction element is configured for providing a zero-order diffractive effect.

### FIELD OF THE INVENTION

The invention generally relates to optical devices, in particular security devices, for documents, such as banknotes.

### BACKGROUND TO THE INVENTION

It is well known to include security features within documents requiring a level of security, for example banknotes. Such security features can take on a number of forms, however particularly useful features are ones that are visually apparent and, therefore, inspectable with relative ease.

However, unscrupulous counterfeiting groups have become better organised and more technically competent, and the high returns from counterfeiting—in spite of the risks, have become more readily appreciated. Over recent years, attempts at simulation of genuine devices have become more and more successful. This problem is exacerbated by the fact that the authentication process for the banknote by members of the public has long been recognised as the weakest point in the security system. Often, such security features require inspection by members of the public to be useful, but may be overly complicated to correctly view or may not provide a strong effect that is easily recognised. This diminishes the usefulness of such features in allowing the public to take an active role in reducing the cost of counterfeiting.

Therefore, it is desirable to provide security features which are difficult to reproduce and, therefore, counterfeit, while engaging the public such that regular authentication of banknotes can take place. Security features which provide a surprising visual effect, for example revealing a hidden image that is not normally visible, while not requiring specialist equipment, are particularly desirable.

### SUMMARY OF THE INVENTION

According to an aspect of the present invention there is provided an optical device, preferably a security device for a security document, including: a first surface; and an arrangement of pixels on the first surface, wherein each pixel includes a zero-order diffraction element, such that each zero-order diffraction element is configured for providing a zero-order diffractive effect, and wherein the arrangement of pixels is configured to provide an image, wherein the image includes an arrangement of microimages.

Preferably, the size of each pixel is the same. Each pixel may have a dimension in the order of 5 to 100 microns.

In embodiments, each pixel has an associated brightness. The associated brightness of each pixel may be selected from one of a finite number of brightness levels, such as 16 brightness levels. Alternatively, the associated brightness of each pixel may be selected from a continuous range of brightness levels. The zero-order diffraction element of each pixel may be located within an active region of the pixel, configured such that the brightness of each pixel is determined by the size of the active region of the pixel. The optical device may further include one or more non-diffractive pixels, each non-diffractive pixel corresponding to a minimum brightness level.

Optionally, each zero-order diffraction element includes a periodic arrangement of grating elements. The period of the arrangement of grating elements for each zero-order diffraction element may be the same. Preferably, the grating period is not greater than 500 nm, more preferably not greater than 300 nm and even more preferably not greater than 250 nm. In embodiments, each zero-order diffraction element has a colour associated with it, and the period of the arrangement of grating elements for each zero-order diffraction element is determined at least in part based on the colour associated with it. The colour associated with each zero-order diffraction element may correspond to the appearance of the zero-order diffraction element when the optical device is viewed from a common position.

The grating elements of the optical device may have grating heights or depths of 500 nm or less, preferably between 60 and 250 nm. In one embodiment, the grating elements may have grating heights or depths between 60 and 150 nm. Such a range of grating heights or depths can be used to generate special zero order colour effects depending on other factors such as grating period.

In an embodiment, the grating elements may have grating heights or depths between 120 and 250 nm. The range of heights or depths can give very bright diffraction efficiencies for high spatial frequency gratings, for example with grating periods of 250 nm or less.

The optical device optionally further includes a first opaque layer, optionally black or white, preferably white, applied to a second surface of the substrate opposite the first surface. In an alternative option, the optical device further includes an array of microlenses formed on a second surface of the substrate, microlenses of the microlens array configured for viewing the arrangement of pixels. Where applicable, the optical device may further include a second opaque layer, optionally black or white, preferably white, applied to the arrangement of pixels thereby covering the arrangement of pixels.

According to a second aspect of the present invention, there is provided an optical system including an optical device according to the first aspect and a verification device, the verification device including a microlens array including an arrangement of microlenses, wherein the microlens array is configured to provide an optical effect, preferably a moiré effect or an image switch effect, when positioned overlapping the optical device such that the microlenses view the image

According to a third aspect of the present invention, there is provided a document, preferably a security document such as a banknote, including the optical device or optical system of the previous aspects.

According to a fourth aspect of the present invention, there is provided a method for manufacturing an optical device according to the first aspect, the method including the steps of: applying a radiation curable ink (RCI) to a first surface of a substrate; embossing the RCI using a high resolution embossing device; and curing the RCI.

The high resolution embossing device may be manufactured using a method incorporating electron beam lithography. Electron beam lithography may be utilised to create a master template, which is in turn may be utilised to manufacture the high resolution embossing device.

The method optionally includes a step of forming a microlens array, preferably an embossed microlens array, of a second surface of the substrate, such that microlenses of the microlens array are configured for viewing an image associated with the RCI.

According to fifth aspect of the present invention, there is provided a method for manufacturing a document according to the third aspect, including the steps of: in a region of a substrate, applying a radiation curable ink (RCI) to a first surface of a substrate, embossing the RCI using a high resolution embossing device; and curing the RCI; and applying to one or both of a first surface and a second surface of the substrate an opacifying layer, wherein the one or both opacifying layers are applied such that the RCI is visible from at least one side of the substrate.

Optionally, the method further includes the step of forming a microlens array, preferably an embossed microlens array, in a different portion of the substrate to the RCI, such that when the banknote is folded or otherwise manipulated so that the microlens array is positioned overlaying the RCI, microlenses of the microlens array are configured for viewing an image associated with the RCI. Alternatively, the method may further include a step of forming a microlens array, preferably an embossed microlens array, of a second surface of the substrate overlapping the RCI, such that microlenses of the microlens array are configured for viewing an image associated with the RCI.

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied.

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

### Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIGS. 1a to 1c each show a document including an optical device;

FIG. 2 shows an optical device according to an embodiment;

FIGS. 3a and 3b show pixels according to different embodiments;

FIG. 4 shows an arrangement of grating elements of a zero-order pixel;

FIG. 5 shows pixels arranged into groups comprising pixels of different colours; and

FIGS. 6a to 6b show embodiments incorporating arrangements of microlenses.

### DESCRIPTION OF PREFERRED EMBODIMENT

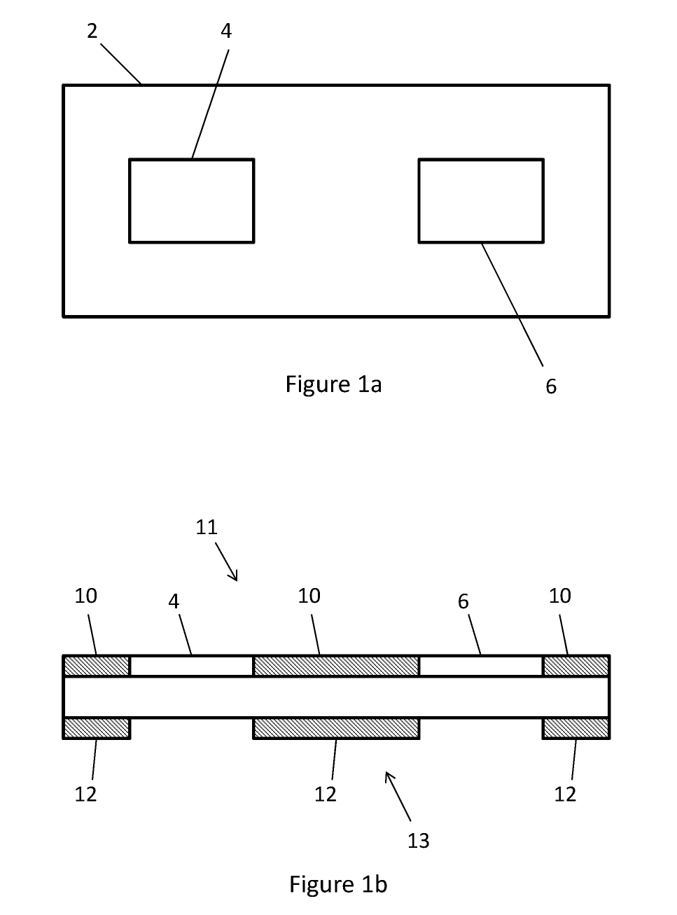

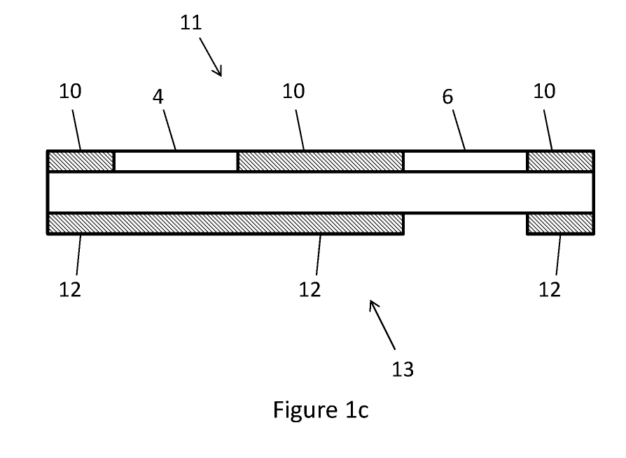

With reference to FIGS. 1a and 1b, there is provided a document 2 including an optical device 4, such as a security device, and an optional verification feature 6. The document 2 can be a security document 2, such as a banknote. The security document 2 can also be any other document which requires a level of security, for example a credit card or passport. The document 2 includes a substrate 8, which can include a first opacifying layer 10 applied to a first side 11 and a second opacifying layer 12 applied to a second side 13. Both the first opacifying layer 10 and the second opacifying layer 12 are shown including window regions corresponding to the optical device 4 and the verification device 6, however it is noted that in some configurations one of the first and second opacifying layers 10, 12 can be configured to cover one of the optical device 4 and the verification device 6, such as shown in FIG. 1c where the second opacifying layer 12 is shown covering the optical device 4. In the case of FIG. 1c, the opacifying layer can correspond to a opaque backing for the optical element 4, such as a white or black backing. In this way, the optical device 4 or the verification device 6 can be formed in a half-window region.

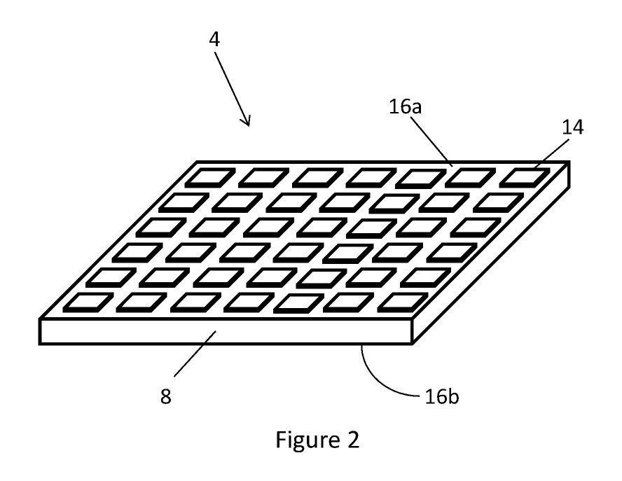

With reference to FIG. 2, the optical device 4 includes a substrate 8 having a first surface 16a and a second surface 16b, corresponding to the first and second sides 11, 13 of the document 2, respectively. The first surface 16a includes an arrangement of pixels 14. As shown in the figure and assumed herein, the arrangement of pixels 14 corresponds to a regular 2D array of pixels 14, however in general the arrangement of pixels 14 can be any suitable arrangement, including a non-regular arrangement. The pixels 14 are arranged in order to form an image which is viewable by a user, or a hidden image which must be revealed by use of one or more verification devices 6. It is understood that the image or hidden image may correspond to an arrangement of microimages, such as a repeating 1D or 2D pattern of microimages. The pixels 14 can each be the same size, wherein the ‘size’ of a pixel 14 as used herein corresponds to the area that the pixel 14 takes up on the first surface 16a.

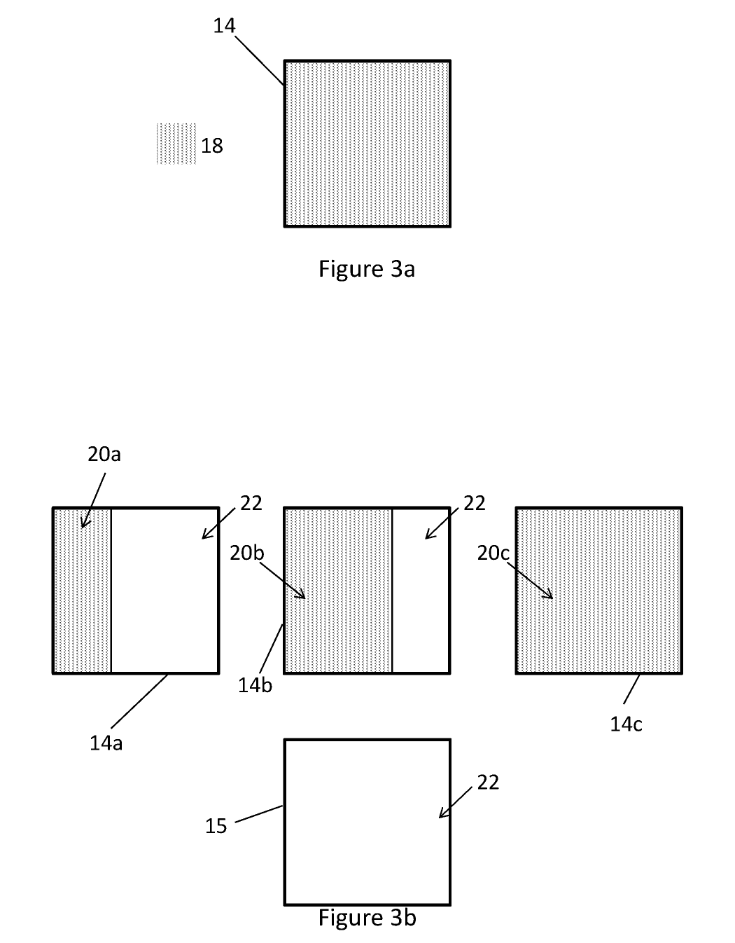

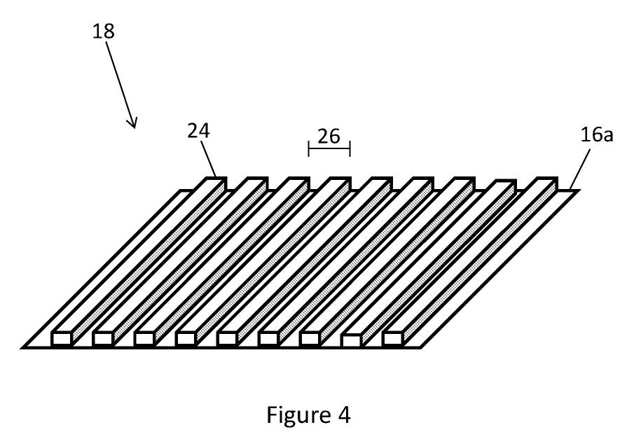

Referring to FIGS. 3a and 3b, each pixel 14 includes a zero-order diffraction element 18 (in the figures the zero-order diffraction element 18 constitutes the shaded portion of the pixel 14), configured for providing a zero-order diffraction visual effect. In the embodiment shown in FIG. 3a, the zero-order diffraction element 18 corresponds to the entire pixel 14. In the embodiment shown in FIG. 3b, each pixel 14 has an active region 20, wherein the diffractive element 18 is located within the active region 20. The portion of each pixel 14 not including the active region 20 is herein labelled the inactive region 22 of the pixel. As shown in FIG. 3b, different pixels 14a, 14b, 14c can have differently sized active regions 20a, 20b, 20c. Different sizes of active regions 20 result in different brightness of the corresponding pixels 14, with a large active region 20 associated with a brighter pixel 14. ‘Brightness’ as used herein corresponds to relative brightness between pixels 14. Preferably, maximum brightness corresponds to the largest active region 20 associated with a pixel 14. Also shown in FIG. 3b is a non-diffractive pixel 15. The non-diffractive pixel 15 corresponds to a pixel 14 with only an inactive region 22. The non-diffractive pixel 14 therefore corresponds to a minimum brightness pixel 14. Each pixel 14 can have a brightness selected from a finite range of brightness levels (e.g. 16 levels), or alternatively, the brightness of each pixel 14 is selected from a continuous range of brightness levels.

Referring to FIG. 4, each zero-order diffraction element 18 includes an arrangement of grating elements 24. In the configuration shown, the grating elements 24 correspond to projections from the first surface 16a of the optical device 4. Other configurations include grating elements 24 corresponding to grooves or depressions in the first surface 16a, or areas of different refractive index when compared to the substrate 8 in which the grating elements 24 are embedded, or a layer applied to the substrate 8 in which the grating elements 24 are embedded. As shown, the grating elements 24 are present in a linear periodic arrangement with a constant grating element period 26 and a constant grating element height or depth. For example, the grating period is below 500 nm, preferably below 300 nm, and more preferably below 250 nm. Grating heights or depths are, preferably, 500 nm or less, and more preferably between 60 and 250 nm. In some embodiments, the grating heights or depths may be between 60 and 150 nm, or between 120 nm and 250 nm, depending on the zero-order effects required. The pitch and widths of the grating elements is preferably 500 nm or less, and more preferably between 60 and 250 nm.

In an embodiment, each zero-order diffraction element 18 of the optical device 4 has a common constant grating element period 26, and a common grating alignment. An image is provided due to variation in the brightness of each pixel 14 based on the size of an active region 20 as described with reference to FIG. 3b. For example, for a monochromatic 2-colour image, each pixel 14 can be selected to have one of two brightness levels. In a particular implementation of this example, one brightness level corresponds to a pixel 14 with no inactive region 22 and the other brightness level corresponds to a pixel 14 with no active region 20 (i.e. a non-diffractive pixel 15). In another example, a 16-colour image can be created where each pixel 14 has a brightness level selected from one of 16 levels (where the minimum brightness level can correspond to a non-diffractive pixel 15). In this embodiment, when the optical device 4 is viewed from a predetermined position, the optical device 4 may appear to as a monochromatic colour image. The colour of the image is at least determined by the common grating period 26, and may further be determined by choice of: substrate 8 material, grating element 24 material, coating between the substrate 8 and grating elements 24, coating covering the grating elements 24, etc. In general, for a particular optical device 4, the colour can be determined through routine experimental variation of grating period 26.

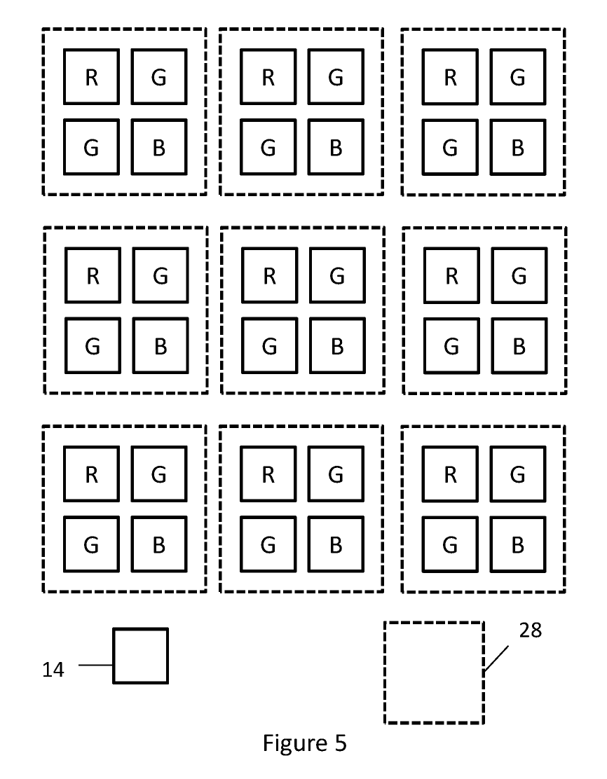

Another embodiment corresponds to a variation of the previously described embodiment. In this embodiment, each pixel 14 can have a colour selected from two or more colours. The colour of each pixel 14 corresponds to the colour of the pixel 14 when viewed from a predetermined common viewing position. In one implementation of this embodiment, each pixel 14 has a colour selected from one of three colours, namely red, green, and blue. Each pixel 14 further has an associated brightness as previously described. In this way, an RGB image can be produced. As shown in FIG. 5, the pixels 14 are arranged into groups 28 including pixels 14 associated each possible colour (red, green, blue). In order to maintain a regular 2D arrangement of pixels 14, there may be two of pixels of a colour in a group 28 (such as the two green pixels shown in FIG. 5).

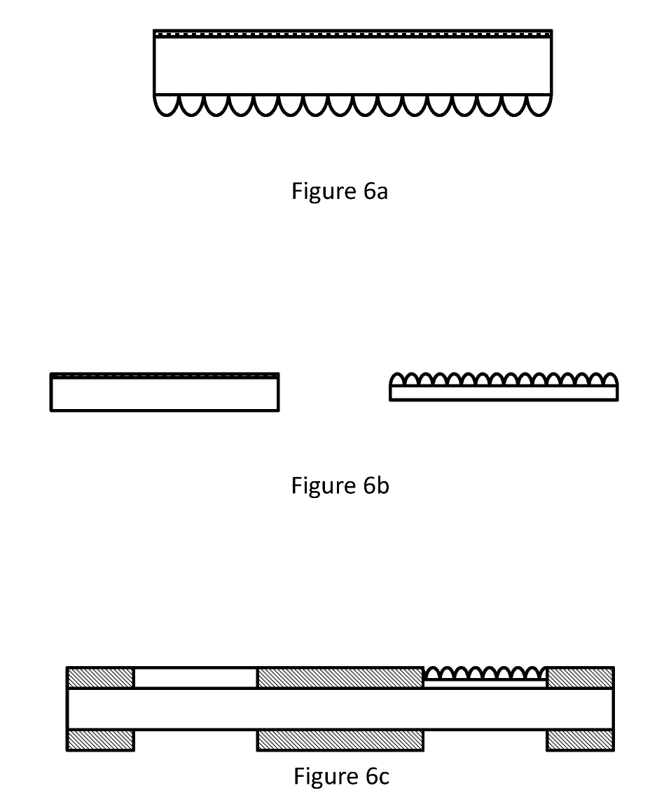

Referring to FIGS. 6a to 6c, a microlens array 30 is provided for viewing the pixels 14 of a pixel layer 30. In FIG. 6a, the microlens array 30 is provided on the opposite surface (second surface 16b) of the substrate 8 to the pixel layer 30, and configured for focussing on the pixels 14 of the pixel layer 30. In FIG. 6b, the microlens array 30 is provided in a separate portion of the substrate 8 to the microlens array 30, thereby forming a verification element of a verification device 32.

In FIG. 6c, the microlens array 30 is provided as a verification device corresponding to the verification feature 6 of the document 2. In this case, the microlenses of the microlens array 30 are configured for focussing on the pixels 14 of the optical device 4 when the document 2 is folded or otherwise manipulated such that the microlens array 30 is overlapping the optical element 4, preferably in contact with either the first side 11 or second side 13.

The microlens array 30 is suitable for viewing an arrangement an image corresponding to an arrangement of microimages. An advantage of pixels 14 having zero-order diffraction elements 18 is that high resolution imagery is possible. Zero-order diffraction elements 18 are advantageous in comparison to first and higher order diffraction elements as it has been found that microlenses act to recombine first and higher order diffraction effects, thereby reducing the effectiveness of such gratings for use in microlens and microimage based optical devices. Therefore, zero-order diffraction ratings 18 can provide for high contrast, high resolution microimagery. High resolution imagery can correspond to pixels with a dimension in the order of 5 to 100 microns. For example, a square pixel can have a length and breadth each of 5 to 100 microns. A circular pixel can have a diameter of 5 to 100 microns. Decreasing pixel size affects the amount of light that each individual pixel reflects and, therefore, the particular application will determine the ideal size of the pixel.

As the grating spacing of the zero-order grating elements 18 of the pixels 14 is relatively low, high resolution techniques are required for forming the pixels 14. One such technique for forming the pixels 14 uses embossing with a high resolution embossing device. The high resolution embossing device can be created with a method incorporating electron beam lithography, which enables the formation of high detail (and therefore high resolution) features on a surface. A master template can be created using electron beam lithography, which can then be utilised to create the high resolution embossing device. The arrangement of pixels 14 can be formed by first applying a radiation curable ink (RCI) to a first surface of the substrate 8, and embossing the radiation curable ink using the embossing tool. Due to surface tension effects, it may be desirable to cure the RCI before removing the embossing tool, such that the structure of the zero-order grating elements 18 is maintained. The RCI is preferably cured using appropriate radiation, for example a UV curable ink can be cured by exposure to UV radiation. It is understood that other inks and curing methods can be used, for example heat curable inks.

Further modifications and improvements may be made without departing from the scope of the present invention.

1.-25. (canceled)

26. An optical device including:
a first surface; and
an arrangement of pixels on the first surface, wherein a plurality of the pixels includes a zero-order diffraction element,
such that each zero-order diffraction element is configured for providing a zero-order diffractive effect, and wherein the arrangement of pixels is configured to provide an image, wherein the image includes an arrangement of microimages.

27. An optical device as claimed in claim 26, wherein the size of each pixel is the same and each pixel has a dimension of 5 to 500 microns.

28. An optical device as claimed in claim 26, wherein each pixel has an associated brightness, the associated brightness of each pixel being selected from one of a finite number of brightness levels and/or from a continuous range of brightness levels.

29. An optical device as claimed in claim 28, wherein the zero-order diffraction element of each pixel is located within an active region of the pixel, configured such that the brightness of each pixel is determined by the size of the active region of the pixel.

30. An optical device as claimed in claim 28, further including one or more non-diffractive pixels, each non-diffractive pixel corresponding to a minimum brightness level.

31. An optical device as claimed in claim 26, wherein each zero-order diffraction element includes a periodic arrangement of grating elements and the period of the arrangement of grating elements for each zero-order diffraction element is the same.

32. An optical device as claimed in claim 31, wherein each zero-order diffraction element has a colour associated with it, and wherein the period of the arrangement of grating elements for each zero-order diffraction element is determined at least in part based on the colour associated with it.

33. An optical device as claimed in claim 32, wherein the colour associated with each zero-order diffraction element corresponds to the appearance of the zero-order diffraction element when the optical device is viewed from a common position.

34. An optical device as claimed in claim 31, wherein the grating elements have grating depths or heights of 500 nm or less, preferably between 60 and 250 nm.

35. An optical device as claimed in claim 26, further including an array of microlenses formed on a second surface of the substrate, wherein the first and second surfaces correspond to opposite sides of a transparent or translucent substrate, wherein the array of microlenses are configured for viewing the arrangement of pixels.

36. An optical device as claimed in claim 26, further including a first opaque layer, optionally black or white, preferably white, applied to the arrangement of pixels thereby covering the arrangement of pixels.

37. An optical system including an optical device as claimed in claim 26 and a verification device, the verification device including a microlens array including an arrangement of microlenses, wherein the microlens array is configured to provide an optical effect, preferably a moiré effect or an image switch effect, when positioned overlapping the optical device.

38. A document, preferably a security document such as a banknote, including the optical device as claimed in claim 26.

39. A method for manufacturing an optical device as claimed in claim 26, the method including the steps of:
applying a radiation curable ink (RCI) to a first surface of a substrate;
embossing the RCI using a high resolution embossing device; and
curing the RCI.

40. A method as claimed in claim 39, wherein the high resolution embossing device is manufactured using a method incorporating electron beam lithography.

41. A method as claimed in claim 40, wherein electron beam lithography is utilised to create a master template, which is in turn utilised to manufacture the high resolution embossing device.

42. A method as claimed in claim 41, including a step of forming a microlens array, preferably an embossed microlens array, of a second surface of the substrate, such that microlenses of the microlens array are configured for viewing an image associated with the RCI.

43. A method for manufacturing a document as claimed in claim 40, including the steps of:
in a region of a substrate, applying a radiation curable ink (RCI) to a first surface of a substrate, embossing the RCI using a high resolution embossing device; and curing the RCI; and
applying to one or both of a first surface and a second surface of the substrate an opacifying layer,
wherein the one or both opacifying layers are applied such that the RCI is visible from at least one side of the substrate.

44. A method as claimed in claim 43, further including the step of forming a microlens array, preferably an embossed microlens array, in a different portion of the substrate to the RCI, such that when the banknote is folded or otherwise manipulated so that the microlens array is positioned overlaying the RCI, microlenses of the microlens array are configured for viewing an image associated with the RCI.

45. A method as claimed in claim 43, including a step of forming a microlens array, preferably an embossed microlens array, of a second surface of the substrate overlapping the RCI, such that microlenses of the microlens array are configured for viewing an image associated with the RCI.
